(19) United States
(12) Patent Application Publication
(10) Pub. No.: US 2008/0299035 A1
(43) Pub. Date: Dec. 4, 2008

(54) Method for recycling used sputtering target

(75) Inventors: Hsin-Chun Lu, Taipei City (TW); Chih-Ming Hsieh, Jhongli City (TW); Yi-Chieh Chen, Kaohsiung City (TW); Cherng-Yuan Shiao, Jhongli City (TW); Kuo-Shu Hsu, Banciao City (TW); Nai-Sheng Syu, Bade City (TW)

Correspondence Address: TROXELL LAW OFFICE PLLC, SUITE 1404, 5205 LEESBURG PIKE, FALLS CHURCH, VA, 22041, US

(73) Assignee: CHENG LOONG CORPORATION

(21) Appl. No.: 11/806,250

(22) Filed: May 30, 2007

(51) Int. Cl. C01G 15/00; C01G 19/02

(52) U.S. Cl. 423/594.9

(57) ABSTRACT

A method for recycling a used sputtering target is provided, including the steps of: (1) cleaning, (2) pulverization, (3) dissolution, (4) filtering, (5) peptization, (6) neutralization and precipitation, (7) rinsing and filtering, (8) drying, and (9) calcination; through the steps above, which can then be recycling used sputtering target to recover the constituent components of the ITO targets.

### FIELD OF THE INVENTION

The present invention relates to a method for recycling sputtering target material, and in particular to a method particularly suitable for recycling the material of a used ITO (indium tin oxide) sputtering target or the likes.

### BACKGROUND OF THE INVENTION

Sputtering coating is carried out by depositing a substance of a target onto a substrate. This method is broadly applied in the manufacturing of various film-like articles. Taking ITO film as an example, the film has good electrical conductivity and excellent transmittance of visible light and excellent reflectivity for infrared rays so that the film is often employed in electro-optic devices and photo-electric devices.

In processing a used sputtering target, the following process is commonly adopted to recycle the used target:

(1) pulverization: wherein external forces are applied to the used target to pulverize the target;

(2) dissolution: wherein acid solution is employed to dissolve and retrieve indium and tin from the pulverized target;

(3) selective precipitation: wherein the solution of step (2) is adjusted for pH value by adding alkali solution to precipitate tin and the tin precipitation is then removed;

(4) displacement: wherein zinc pads are positioned in the solution of the used target of which tin has been removed to allow zinc to replace indium so as to reduce indium ions contained in the solution into indium sponge;

(5) electrolysis: wherein the indium sponge is removed from the solution of used target and is subject to heating and melting to obtain crude indium and the crude indium is cast to form indium anode board, which is then positioned in an electrolysis bath for refining of indium; and

(6) casting: wherein indium is removed from a cathode member of the electrolysis and is molten and the indium melt is poured in dies for casting thereby recovering refined indium metal ingots.

The final product of the above discussed conventional process includes indium metal, rather than ITO, and it takes various steps to manufacture a sputter target from indium metal, in which steps, a great amount of energy is consumed. Thus, the conventional process is disadvantageous for mass production. In addition, disposition of the used electrolyte used in the electrolysis of indium is also a challenge to environment protection and conversation.

Thus, the present invention is aimed to provide a method for recycling used sputtering target with reduced consumption of resources and less pollution to the environments, which method is applicable in a large-scale recycling of ITO substance from used sputtering targets.

### SUMMARY OF THE INVENTION

An objective of the present invention is to provide a method for recycling used sputtering target to recover the constituent components of the sputtering target.

Another objective of the present invention is to provide a method for recycling used sputtering target with high recycling rate, low pollution, low costs, and consuming less resources, to recover indium.

To realize the above objectives, in accordance with the present invention, a method for recycling a used sputtering target is provided, comprising the steps of: (1) cleaning: in which an acid solution is used to remove foreign objects from the used sputtering target; (2) pulverization: in which forces are applied to break and pulverize the used sputtering target into small pieces/particles having a dimension smaller than 300 microns; (3) dissolution: in which an acid solution of a temperature of 50-150° C. is added to the pulverized target and is well stirred to dissolve the pulverized target pieces to form a target solution containing the target pieces; (4) filtering: in which the target solution is filtered to remove impurities; (5) peptization: in which an alkali solution is added to the target solution to adjust and control pH value thereof so that suspension particles are formed in the target solution that is originally clear, and the solution is subject to continuous stirring for uniformly distributing the particles; (6) neutralization and precipitation: in which the peptized solution is further added with an alkali solution for adjustment of pH value thereof to induce complete precipitation of the solution; (7) rinsing and filtering: in which the target solution is filtered to obtain cakes and the cakes are broken with pure water, and these are repeated at least once to form a suspension; (8) drying: in which the suspension is dried and white powders of indium tin hydroxide are obtained; and (9) calcination: in which the white powders of indium tin hydroxide are calcined in a high temperature oven to obtain yellowish green powders of indium tin oxide, which can then be used to make ITO targets.

### BRIEF DESCRIPTION OF THE DRAWINGS

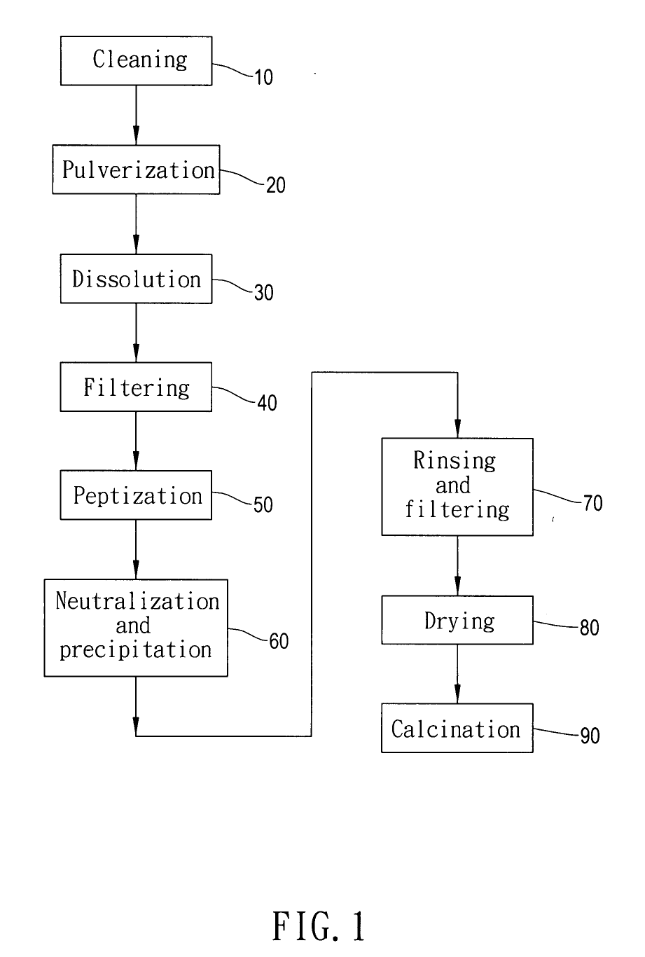

The present invention will be apparent to those skilled in the art by reading the following description of a best mode for carrying out the present invention, with reference to the sole drawing, FIG. 1 that shows a flow chart of a method for recycling a used sputtering target in accordance with the present invention.

### DETAILED DESCRIPTION OF THE BEST MODE FOR CARRYING OUT THE PRESENT INVENTION

With reference to the sole drawing, FIG. 1, a method for recycling a used sputtering target in accordance with the present invention comprises the following steps:

Cleaning (step 10): in which an acid solution is used to remove foreign objects from the used sputtering target;

Pulverization (step 20): in which forces are applied to break and pulverize the used sputtering target into small pieces/particles having a dimension smaller than 500 microns;

Dissolution (step 30): in which an acid solution of a temperature of 50-150° C. is added to the pulverized target and is well stirred to dissolve the pulverized target pieces to form a target solution containing the target pieces;

Filtering (step 40): in which the target solution is filtered to remove impurities;

Peptization (step 50): in which an alkali solution is added to the target solution to adjust and control pH value thereof so that suspension particles are formed in the target solution that is originally clear, and the solution is subject to continuous stirring for uniformly distributing the particles;

Neutralization and precipitation (step 60): in which the peptized solution is further added with an alkali solution for adjustment of pH value thereof to induce complete precipitation of the solution;

Rinsing and filtering (step 70): in which the target solution is filtered to obtain cakes and the cakes are broken with pure water, and these are repeated at least once to form a suspension;

Drying (step 80): in which the suspension is dried and white powders of indium tin hydroxide are obtained; and

Calcination (step 90): in which the white powders of indium tin hydroxide are calcined in a high temperature oven to obtain yellowish green powders of indium tin oxide.

In a practical application, an acid solution is first used to dissolve and remote the foreign objects from a surface of a used sputtering target. Then, a pneumatic device or other external force generator is employed to break the used sputtering target into pieces having a dimension smaller than 500 microns. An acid solution containing halogen and have a temperature of 50-150° C. is added and well stirred to dissolve the target pieces. The acid solution can be a mixture of acids. It is noted that only hot acid solution containing halogen and having a concentration of 6-15N can effectively dissolve the target piece to an extent of 99.8% dissolution rate. The target dissolved solution is then filtered to remove impurities. Thereafter, an alkali solution of 1-15N concentration is added to adjust the pH value to 1-6. The solution is then stirred for 2-72 hours for peptization, and an alkali solution of 1-12N concentration is further added to the peptized target dissolved solution to regulate the pH value to the range of 3-9 so that precipitation Occurs in the solution that is originally clear. The solution is filtered to obtain cakes and the cakes are broken with pure water, these being repeated at least once to form a suspension. The suspension is subject to drying to obtain white powders of indium tin hydroxide. The white powders of indium tin hydroxide are positioned into a high temperature oven and is subject to calcination at the conditions that temperature is increased at a rate of 1-20° C. per minute and is maintained at 300-1100° C. for 0.5-5 hours, so as to obtain yellowish green powders of indium tin oxide, which can then be used to make sputtering targets.

In accordance with the present invention, in the step of dissolution, adding a hot acid solution containing halogen and having a concentration of 6-15N and a temperature of 50-150° C. can effectively dissolve the target piece to an extent of 99.8%. Adding an alkali solution in the solution containing the used target neutralize the solution and substance of sputtering target, rather than metal indium, is recovered and can be directly used to make sputtering targets.

The present invention provides a novel method for recycling a used sputtering target, which effectively overcomes the drawbacks of the conventional method that uses room-temperature acid solution. A dissolution rate of as high as 99.8% of the used target can be obtained with hot acid solution in accordance with the present invention so that no additional indium resources is needed. Thus, natural resources can be conserved and manufacturing costs of sputtering targets are reduced.

Although the present invention has been described with reference to a best mode for carrying out the present invention, it is apparent to those skilled in the art that a variety of modifications and changes may be made without departing from the scope of the present invention to which is intend be defined by the appended claims.

What is claimed is:

1. A method for recycling a used sputtering target, comprising the following steps:
(1) cleaning: in which an acid solution is used to remove foreign objects from a used sputtering target;
(2) pulverization: in which forces are applied to break and pulverize the used sputtering target into small pieces/particles having a dimension smaller than 500 microns;
(3) dissolution: in which a hot acid solution is added to the pulverized target pieces and stirred to dissolve the pulverized target pieces to form a solution containing the target pieces;
(4) filtering: in which the solution containing the target pieces is filtered to remove impurities;
(5) peptization: in which an alkali solution is added to the solution containing the target pieces to adjust and control pH value so that suspension particles are formed in the solution that is originally clear, the solution being subject to continuous stirring;
(6) neutralization and precipitation: in which the peptized solution is further added with an alkali solution for adjustment of pH value to induce complete precipitation of the solution;
(7) rinsing and filtering: in which the solution is filtered to obtain cakes and the cakes are broken with pure water, these being repeated at least once to form a suspension;
(8) drying: in which the suspension is dried to obtain white powders of indium tin hydroxide; and
(9) calcination: in which the white powders of indium tin hydroxide are calcined in a high temperature oven to obtain yellowish green powders of indium tin oxide.

2. The method as claimed in claim 1, wherein the step of pulverization comprises employing a pneumatic device to pulverize the used sputtering target.

3. The method as claimed in claim 1, wherein the hot acid solution of the step of dissolution is of a temperature of 50-150° C.

4. The method as claimed in claim 1, wherein the acid solution of the step of dissolution contains halogen and has a concentration of 6-15N.

5. The method as claimed in claim 4, wherein the acid solution containing halogen comprises a mixture of acids.

6. The method as claimed in claim 1, wherein the alkali solution of the step of peptization has a concentration of 1-15N for adjusting the pH value to a range of 1-6 and wherein the stirring is conducted for a period of 2-72 hours.

7. The method as claimed in claim 1, wherein the alkali solution of step of neutralization and precipitation has a concentration of 1-12N for adjusting the pH value to a range of 3-9.

8. The method as claimed in claim 1, wherein calcination of the step of calcination is conducted in the high temperature oven at a temperature increasing rate of 1-20° C. per minute and wherein the temperature of the oven is then maintained in the range of 300-1100° C. for a period of 0.5-5 hours.
